(19) United States
(12) Patent Application Publication
(10) Pub. No.: US 2005/0250501 A1
(43) Pub. Date: Nov. 10, 2005

(54) Method and system for routing calls from a wireless telephone network to a wire-line telecommunications services platform

(76) Inventors: Farzad Mobin, Palo Alto, CA (US); Robert John Stewart, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/013,262

(22) Filed: Dec. 14, 2004

Related U.S. Application Data
(60) Provisional application No. 60/569,459, filed on May 10, 2004.

(51) Int. Cl. H04Q 7/20

(52) U.S. Cl. 455/445

(57) ABSTRACT

A telecommunications network includes a mobile switching center (MSC) and a service control point (SCP) communicatively coupled to one another. The SCP is configured to provide the MSC with call routing information for a mobile telephone call received at the MSC so as to direct the call to a wire-line prepaid telephone service provider platform (WPP) in accordance with calling number identification information received at the MSC. The call routing information may include a temporary routing number (TRN) to be used by the MSC to connect the mobile telephone call to the WPP, a carrier identification code, or steering digits prepended to a called number.

### RELATED APPLICATION

This application is related to, incorporates by reference and hereby claims the priority benefit of U.S. Provisional Patent Application No. 60/569,459, entitled “Wireless Prepaid”, filed May 10, 2004 by the present inventors.

### FIELD OF THE INVENTION

The present invention relates to a system and method for routing calls from a mobile (wireless) telephone network to a wire-line telecommunications services platform, for example as operated by a wire-line prepaid telephone services provider.

### BACKGROUND

Cellular or mobile (wireless) telephone service has become ubiquitous throughout virtually the entire world. Mobile prepaid service accounts for a steadily increasing portion of the global revenues derived from such telephone service. In this context, mobile prepaid service refers to mobile telephone service in which the user pays for such service in advance of using it. Typically, these services are pre-purchased on a per-minute of airtime basis.

To date, four approaches have been implemented to provide mobile prepaid service: a handset-based approach, a hot billing approach, a service node approach and a wireless intelligent network (WIN) approach. Each has its own advantages and disadvantages.

The handset-based approach is generally applicable only to mobile phones configured for use with the Global System for Mobile Communications (GSM) or specially customized phones. With GSM, each phone (handset) has an associated subscriber identity module (SIM) card programmed with credit information. During call set-up, a mobile switching center (MSC) in the mobile telecommunications service provider's network provides tariff information to the SIM card in the handset, and that information is used to debit the user's account during the call. The handset-based approach is generally not favored because of the potential for fraud.

The hot billing approach uses call detail records (CDRs) to process prepaid usage. Briefly, a CDR is created in the MSC after completion of a call and is subsequently provided to the user's prepaid service provider so that the user's account can be properly debited. As may be evident, this approach requires the use of data collection/routing equipment otherwise ancillary to the mobile telecommunications service provider's network in order to provide account reconciliation and so is generally not favored by such service providers.

The service node approach has been widely deployed, but has its limits. This approach relies on a service node being co-located with an MSC and connected thereto using dedicated trunks assigned to blocks of prepaid numbers. The user initiates a call by dialing the called party's telephone number. The MSC identifies that the caller is a prepaid customer (based on the calling party's number) and sets up a trunk to the service node. The service node consults a prepaid billing platform to confirm that sufficient credit remains in the user's account to connect the call and, assuming that is the case, sets up a trunk back to the MSC and, eventually, to the called party.

The service node approach thus requires the use of two trunks between the MSC and the service node. If high-speed trunks are used (e.g., to reduce call set-up time), the cost of this solution can be quite high. For this reason, the service node approach offers only limited capacity, as the number of trunks cannot be increased indiscriminately.

Finally, in the WIN approach a prepaid service control point (P-SCP) communicates with the MSC through an SS7 signaling network to exchange WIN triggers that control call set-up and handling. The prepaid customer initiates a call by dialing the called party's number. This time, the MSC encounters a WIN call set-up trigger and sends a request for instructions to the P-SCP. The P-SCP determines whether the caller has sufficient credit to make the call (e.g., by querying its database of prepaid account information) and instructs the MSC to permit or deny the call accordingly. Assuming the call is allowed to proceed, the MSC resumes the call set-up process and eventually the call is connected to the called party. When the call ends, the MSC receives a WIN call release trigger, which sends a disconnect message to the P-SCP. This message is used by the P-SCP to update the caller's prepaid account balance and the P-SCP also instructs the MSC to release the call. In some cases, additional instructions from the P-SCP during the call set-up process (or even during the call itself) may result in the MSC establishing connections with an interactive platform that can communicate information such as account balances to the prepaid customer.

Although this conventional WIN approach provides a viable option for mobile prepaid services, customers are limited to the use of the mobile service provider's infrastructure. Stated differently, callers are not afforded the opportunity to make use of other prepaid service providers' platforms and so cannot benefit from potentially lower rates available through those providers. Such low-cost, prepaid calling plans are commonly used in the case of wire-line communications and generally involve the caller dialing a special telephone number to connect to the service provider's network. If the caller were to now try to make use of such a calling plan using his or her mobile phone, the caller would be forced to first dial the calling plan provider's special number, likely enter a personal identification number (PIN) or other access code, and then dial the actual called party's number.

At best this “solution” is inconvenient, but it also has the potential for the customer to be double billed. First, the caller is forced to dial multiple different numbers. Second, the caller may be billed not only for the cost of a call to the prepaid service provider's number by the caller's mobile service provider, but also for the cost of the call to the called party by the caller's prepaid service provider. These additive charges may be significant if no local number for the prepaid service provider is available and/or if the ultimate call is to an international number. Under such an arrangement then, the caller would be forced to keep track of two separate account balances or the different service providers involved in the call would need to be parties to some form of common billing arrangement.

For at least the foregoing reasons an alternative solution for providing prepaid mobile services is required.

### SUMMARY OF THE INVENTION

One embodiment of the present invention provides a telecommunications network that includes a mobile switching center (MSC) and a service control point (SCP) communicatively coupled to one another. The SCP is configured to provide the MSC with call routing information for a mobile telephone call received at the MSC so as to direct the call to a wire-line prepaid (or postpaid) telephone service provider platform (WPP) in accordance with calling number identification information received at the MSC. The call routing information may include a temporary routing number (TRN) to be used by the MSC to connect the mobile telephone call to the WPP, a carrier identification code, or steering digits prepended to a called number. In some embodiments, the SCP may include a database configured to permit storage of a calling party and called party identification information (e.g., calling and called numbers associated with the mobile telephone call) and to associate the calling party and called party identification information with the TRN to be used by the MSC to connect the mobile telephone call to the WPP.

In a further embodiment, the present invention provides a process for receiving at an SCP a request for call routing instructions for a mobile telephone call, and transmitting a response thereto, which response includes instructions to direct the mobile telephone call to a WPP in accordance with calling number identification information received at the SCP. Prior to transmitting the response, the WPP to which the mobile telephone call is to be routed may be identified based on the calling number identification information. The instructions may include a TRN to be used by an MSC to contact the WPP. In such cases, the calling party identification information and called number identification information may be stored at the SCP and with the TRN. Thereafter, the WPP may interrogate the SCP for the called number, which can be retrieved based on the TRN. Alternatively, instead of using a TRN, the instructions to the MSC may include steering digits prepended to a called number identified in the request for call routing instructions or a carrier identification code for a dedicated trunk associated with the WPP.

In yet a further embodiment, the present invention provides a process in which a WPP to which a mobile telephone call received at an MSC should be routed is chosen according to per established criteria for call routing based on a calling number and called number identification information. The called number identification information may include an international call idnetification code, an area code or similar information. Thereafter, call routing instructions for routing the call to a selected WPP may be transmitted to the MSC. As before, the call routing instructions may include a TRN associated with the selected WPP, steering digits indicative of a dedicated trunk associated with the selected WPP, or a carrier identification code. Also, the calling number and called number identification information may be stored and the called number identification information later recalled (e.g., based on the TRN) transmitted to the WPP in response to a request therefore.

### BRIEF DESCRIPTION OF THE DRAWINGS

The present invention is illustrated by way of example, and not limitation, in the figures of the accompanying drawings in which:

FIG. 1 illustrates an example of a network configured for temporary routing number call routing in accordance with an embodiment of the present invention; and

FIG. 2 illustrates an example of a network configured for dedicated trunk call routing in accordance with an embodiment of the present invention.

### DETAILED DESCRIPTION

Described herein are methods and systems for routing calls from a wireless telecommunication service provider's network to a wire-line platform provider's (WPP) switch in a way that enables enhanced use of the WPP's infrastructure for domestic and/or international call routing and termination. In various embodiments, the present methods and systems allow a caller using a mobile phone to simply dial the called number in order to take advantage of reduced calling charges offered by the WPP, rather than having to enter additional call identification numbers for billing or call routing purposes. In some cases, the present methods and systems make use of an enhanced SCP (which may or may not be part of the wireless telecommunication service provider's network) to store the calling party's preferred WPP's identification information and to provide temporary storage of the called number for association with a temporary routing number (TRN) that allows routing of the call from the wireless telecommunication service provider's network to the WPP's network (e.g., via a tandem switch).

Various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with one or more apparatus to perform the operations described herein. These apparatus may be specially constructed for the required purposes, or may comprise one or more general-purpose computer systems, selectively activated or reconfigured by appropriate computer programs stored computer readable media accessible thereby, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

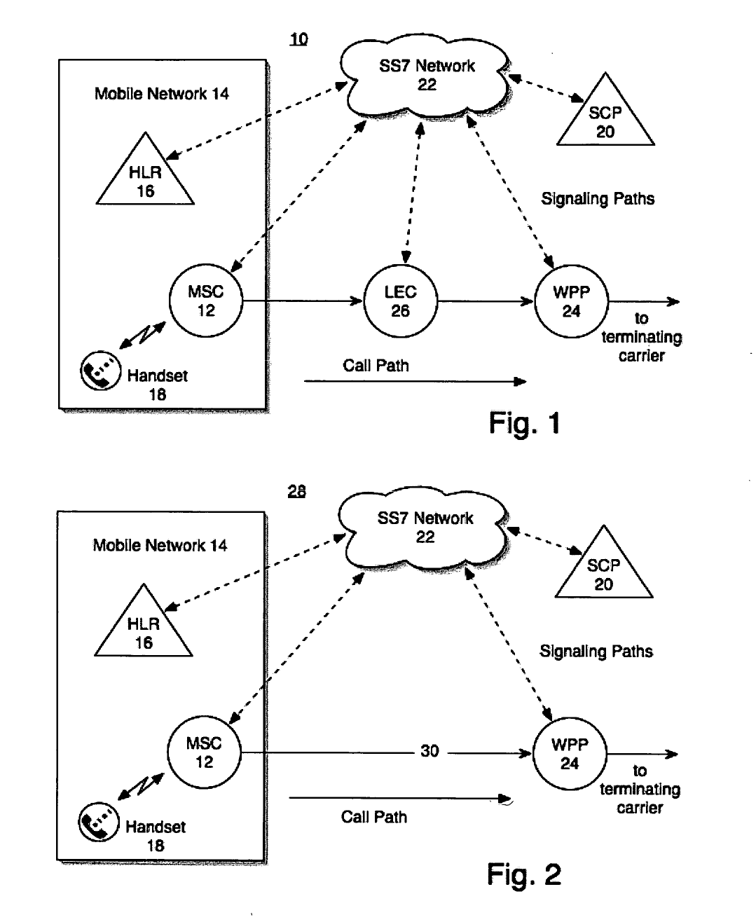

Referring first to FIG. 1, an example of one call flow facilitated through the use of an embodiment of the present invention is discussed with reference to a simplified view of a telecommunications network 10. Network 10 includes an MSC 12, which is part of a larger mobile telephone network 14 deployed by a wireless telecommunication service provider. The mobile telephone network 14 also includes a home location register (HLR) 16. An HLR is the definitive database of mobile subscriber information for a wireless telecommunication service provider's network. It is the real-time list that matches handsets, phone numbers, user accounts and service plan information. It also keeps track of a user's location on the carrier's network (or another carrier's network if roaming) so incoming calls can be routed through the service point. Note that although only one MSC 12 and one HLR 16 are shown in this illustration, wireless network 14 may (and often will) include multiple such devices.

Considering the case of an outbound call, the caller originates the call by dialing the called number (assume in this case it is an international number) from his or her handset 18. The call is received at MSC 12 and, in accordance with the present invention, is held in proxy while the MSC 12 passes a WIN query (or equivalent) to the enhanced SCP 20 via the SS7 network 22. The use of such WIN queries in general is well known in the art and is a feature of the so-called advanced intelligent network (AIN). AIN is a signaling protocol between a service switching point (such as MSC 12) and a centralized network database (e.g., SCP 20). The SCP 20 includes instructions and data that direct switch processing and provide call control. By executing these instructions that analyze the current state of the call and the information received from the MSC 12, SCP 20 can modify or create appropriate call data to instruct MSC 12 as to how to further process the call.

In particular, SCP 20 includes a database of calling numbers so that it can identify mobile repaid customers. That is, at the time a service plan is set up, the SCP 20 will be provided with sufficient information (usually the calling number though in some cases other information such as the handset's electronic identification number (EIN) may be used in addition to or in place of the calling number) to identify the user as a subscriber to a mobile prepaid service plan. Such a plan may permit a user to may use of a designated prepaid service provider's infrastructure so as to avail him/herself of the provider's reduced rates for long distance/international calls. By registering handset 18 in this fashion, upon notification of a call SCP 20 can instruct MSC 12 to route the call to the appropriate prepaid service provider's platform (e.g., a switch or other apparatus) without having the caller provide any additional information. Other information stored at the SCP may include abbreviated or coded information, such as “#11” referring to a landline residence.

Thus, when SCP 20 is notified of the new call, SCP 20 consults the database of prepaid customers and determines that handset 18 is a registered handset. Accordingly, SCP 20 will instruct MSC 12 to route the call to the customer's designated prepaid service provider's platform. Before doing so, however, in this embodiment of the present invention SCP 20 stores the calling number (or other information identifying the originating handset, such as the handset's EIN) and the called number and associates these items with a temporary routing number (TRN). The TRN is a telephone number provided by SCP 20 to MSC 12 and which MSC 12 uses to connect the handset 18 to the prepaid service provider's platform 24.

Using the TRN then, the MSC 12 routes the call from handset 18 to the WPP 24. Preferably, though not necessarily, this call is a local telephone call placed through a local exchange carrier (LEC) 26. In other cases, the call may be routed over a voice over Internet protocol (VoIP) network to WPP 24. In either case, the goal is to avoid the use of expensive long distance networks (and thereby minimize the expense to the caller) and so multiple points of presence for the WPP 24 may be established in locations accessible to the various MSCs through local or other non-toll charge facilities.

With the call now routed to WPP 24, the WPP queries the SCP 20 (e.g., either through the SS7 network 22 or via a direct communication link) for the original called number. The SCP 20 can look up this previously stored information based on the TRN provided by the WPP 24. In addition, the SCP 20 can provide the WPP 24 with the calling number so as to permit the WPP 24 to verify sufficient credit remains in the caller's account to proceed with the call. Assuming such credit is available, the WPP 24 places the outbound call to the called number (received from SCP 20) using the prepaid service provider's outbound carrier routes. Often these routes will be networks owned/operated by third parties with which the prepaid service provider has negotiated low cost call rates.

In the event insufficient credit remains in the caller's account the WPP 24 may deny the call. In addition, if during the call the caller's account balance falls below a required minimum, the call may be terminated. In either or both cases, conventional means (e.g., through the use of intelligent platforms as discussed above) may be used to apprise the caller of his/her account balance and/or to warn the caller that the call is about to be terminated. Also, when the call is complete the TRN can be returned to a pool of such numbers to be used for future calls.

Various alternatives to the above-described call flow exist. For example, the SCP 20 may be programmed to route the call to different WPPs 24 according to whether or not the call is an international call or a domestic call. This way the caller is free to choose different prepaid service providers for different types of calls and take advantage of different rates offered by such providers. The same sort of scheme could be employed at any level of granularity, for example using one service provider for some domestic long distance calls and a different provider for other domestic long distance calls. In such a case, the SCP 20 could distinguish between calls based on the area code of the called number. Alternatively, or in addition, and as explained further below the call may be routed from the MSC 12 to the WPP 24 over dedicated trunks instead of through the public switched telephone network (PSTN) or a VoIP network. Or, where routing over the PSTN is used, instead of using a TRN the present invention may permit use of feature group D (FG-D)-like call routing in which a carrier access code (CAC) proved by the SCP 20 is used to connect the call from MSC 12 to WPP 24 and pass information (such as the calling number) thereto.

The present invention thus permits callers to take advantage of low cost calling rates offered by independent WPPs (i.e., those not associated with wireless carriers) without the caller having to enter special phone numbers or PIN codes. In contrast, conventional networks require that a caller first place a call from a mobile phone to a telephone number associated with the prepaid service provider, then enter a PIN code, and then enter the called party's number. Such inconvenience and associated double billing (once by the mobile service provider and again by the prepaid service provider) diminishes any benefit the caller might otherwise have obtained by using the prepaid service provider's platform to place the outbound call.

In addition, the present invention allows independent prepaid service providers to participate in mobile prepaid calling in a meaningful fashion. With conventional systems, such as those described above, independent prepaid service providers are forced to offer services with little or no margin. This may be because of the double billing issues discussed above, or because the wireless provider requires the use of its own infrastructure or calling plan. In essence the prepaid service provider is relegated to the status of a reseller of the wireless provider's offerings. In contrast, the present invention permits the prepaid service provider to use its own prepaid platform for placing the outbound calls and so the provider is freed from restrictions imposed by the wireless service provider.

As indicated above, rather than making use of TRNs, some embodiments of the present invention may employ dedicated trunk routing between the MSC and the WPP. An example of a network 28 configured in such a fashion is shown in FIG. 2. In this example, the SCP 20 provides instructions for directing the call from the MSC 12 to a specified wire-line carrier provisioned with dedicated trunks 30 to network participating WPPs 24.

As before, the caller need simply dial the called number from handset 18. The call is received at the MSC 12, which then sends a WIN/CAMEL query to the SCP 20 via the SS7 network 22. CAMEL is a feature of GSM networks that enables users to carry personalized services with a handset when roaming. The SCP 20 evaluates the call parameters and determines that the call should be routed to the customer's prepaid service provider (e.g., based on the calling number). Accordingly, the SCP 20 prefixes steering digits to the called number and instructs the MSC 12 to connect the call to the modified called number (i.e., the called number with the prepended steering digits).

Using the steering digits, the MSC 12 routes the call to the WPP 24. The steering digits may identify a particular trunk group from a number of such groups to carry the call. In this way, calls can be routed to the WPPs of the appropriate prepaid service provider. SCP 20 may be programmed with information such as that described above so that calls are routed appropriately based on the calling number and the called number.

As part of its routing process, MSC 12 will strip the steering digits from the called number so that upon receipt of the call the WPP24 may place the call directly to the called number. In other embodiments, the steering digits may be stripped at the WPP 24. Additionally, in some cases the steering digits may be affixed to the end of the called number rather than being prepended thereto.

Although this embodiment of the present invention makes use of dedicated trunks, it does so using only one-half the number of MSC ports as the conventional service node approach described above. Hence, this embodiment of the present invention conserves these precious resources as compared to the service node approach. At the same time, the caller is freed from the need to dial multiple separate numbers and/or PIN codes, etc. All of the call routing is transparent to the caller thanks to the database information stored at the SCP 20 at the time the prepaid service is established.

With any of the embodiments of the present invention, a prepaid service provider can control access to the WPP based on the user's account status. Conventional automated provisioning systems can be employed to prevent a user with a zero balance from incurring charges by repeatedly calling into the prepaid service provider's network only to find out there is no balance. Moreover, any conventional replenishment system can be used to permit a user to add to his or her account balance and regain access to the network.

From the standpoint of the mobile network provider the present invention provides a mechanism for charging the prepaid service provider that is greatly simplified from those presently available. Each call can be measured simply in terms of incoming or outgoing domestic minutes. Thus, the mobile network provider will not need to establish any additional accounting mechanisms for the caller, enabling such a provider to only bill the prepaid service provider for the minutes used on an aggregate basis.

The methods of the present invention using an SCP to provide routing support between a wireless and a wire-line network may also be extended to postpaid mobile applications. Consider, for example, a user having a primary mobile account that allows for unlimited local calls (e.g., within a certain fixed fee pricing plan) but includes variable fees for long distance calls, especially international calls. Such a user could benefit from the present invention by having long distance, and especially international calls, routed to a WPP associated with a provider (either prepaid or postpaid) offering lower cost long distance/international rates.

In such an embodiment, the call would be recognized by the MSC as a long distance or international call, and the MSC would contact the SCP for call handling instructions as described above. In accordance with the present invention, the SCP would select the WPP associated with the caller's provider of choice (e.g., as preconfigured in accordance with the procedures discussed above), perhaps based on the international termination destination and/or the best rates, and the MSC would be instructed to route the call thereto. The SCP may need to maintain appropriate billing records for later reconciliation with the caller's postpaid account provider or such records could be maintained by the WPP of the postpaid account provider.

Likewise, the methods of the present invention using an SCP to provide routing support between a wireless and a wire-line network may also be extended to include calls between different wireless networks. Further, in some cases the incoming call may be routed to an interactive voice response (IVR) application instead of a WPP in order to access additional information. For example, such an UVR application may be used in advance of further routing to another phone or network. Such a system may be used with either prepaid or postpaid accounts.

In various embodiments of the present invention different call variables and/or service options can be used to select which WPP should be used to complete a call. For example, various combinations or ones of the following call variables can be used:
a. Calling phone number;
b. Called phone number;
c. Mobile Identification Number;
d. Originating MSC;
e. Call type; and/or
f. Subscriber class of service
   Regardless of which variables are used, the originating MSC may query the SCP to receive the actual routing instructions for all wireless call originations. Such queries may be made using WIN, CAMEL or other call handling protocols and the choice of such a protocol is not critical to the present invention. Likewise, various methods exist for the MSC to route traffic between the wireless and wire-line networks exist and the choice of the method to be used is not critical to the present invention.

Thus, methods and systems for routing calls between a wireless network and a wire-line network so as to enable use of a WPP's infrastructure for domestic and/or international call routing and termination have been described. Although discussed with reference to certain illustrated embodiments, however, the present invention is not meant to be limited thereby and should only be measured in terms of the following claims.

1. A telecommunications network, comprising a mobile switching center (MSC) and a service control point (SCP) communicatively coupled thereto, the SCP configured to provide the MSC with call routing information for a mobile telephone call received at the MSC so as to direct the call to a wire-line telephone service provider platform (WPP) in accordance with calling number identification information received at the MSC.

2. The telecommunications network of claim 1, wherein wire-line telephone service provider is a prepaid service provider.

3. The telecommunications network of claim 1, wherein wire-line telephone service provider is a postpaid service provider.

4. The telecommunications network of claim 1, wherein the call routing information comprises a temporary routing number to be used by the MSC to connect the mobile telephone call to the WPP.

5. The telecommunications network of claim 1, wherein thecall routing information comprises a carrier identification code.

6. The telecommunications network of claim 1, wherein the call routing information comprises steering digits prepended to a called number.

7. The telecommunications network of claim 1, wherein the SCP includes a database configured to permit storage of the calling number identification information and called number identification information associated with the mobile telephone call and to associate the calling number identification information and called number identification information with a temporary routing number to be used by the MSC to connect the mobile telephone call to the WPP.

8. The telecommunications network of claim 1, wherein prior to directing the call to the WPP, the call is directed to an interactive voice response application.

9. A method, comprising receiving at a service control point (SCP) a request for call routing instructions for a mobile telephone call, and transmitting a response thereto, which response includes instructions to direct the mobile telephone call to a wire-line prepaid telephone service provider platform (WPP) in accordance with calling number-related identification information received at the SCP.

10. The method of claim 9, further comprising, prior to transmitting the response, identifying the WPP to which the mobile telephone call is to be routed based on the calling number-related identification information.

11. The method of claim 10, wherein the instructions include a temporary routing number (TRN) to be used by a mobile switching center (MSC) to contact the WPP (including to a tandem switch ultimately connecting the call to the WPP.)

12. The method of claim 11, wherein the MSC contacts the WPP through a tandem switch.

13. The method of claim 10, further comprising storing the calling number-related identification information and called number-related identification information at the SCP.

14. The method of claim 13, wherein information stored at the SCP includes abbreviated or coded information.

15. The method of claim 13, further comprising associating the calling number-related identification information and called number-related identification information with the TRN.

16. The method of claim 15, further comprising receiving, at the SCP, a request for the called number-related identification information.

17. The method of claim 16, further comprising transmitting the called number-related identification information in response to the request therefore.

18. The method of claim 17, wherein the called number identification information is retrieved according to the TRN, which is included in the request for the called number-related identification information.

19. The method of claim 10, wherein the instructions include steering digits prepended to a called number identified in the request for call routing instructions.

20. The method of claim 10, wherein the instructions include a carrier identification code for routing on a dedicated trunk associated with a specific WPP.

21. A method, comprising choosing a wire-line prepaid telephone service provider platform (WPP) to which a mobile telephone call received at a mobile switching center (MSC) should be routed according to pre-established criteria for call routing based on a calling number and called number identification information.

22. The method of claim 21, wherein the called number identification information includes an international call identification code.

23. The method of claim 21, wherein the called number identification information includes an area code.

24. The method of claim 21, further comprising transmitting to the MSC call routing instructions for routing the call to a selected WPP.

25. The method of claim 24, wherein the call routing instructions include a temporary routing number (TRN) associated with the selected WPP.

26. The method of claim 24, wherein the call routing instructions include steering digits indicative of a dedicated trunk associated with the selected WPP.

27. The method of claim 24, wherein the call routing instructions include a carrier identification code.

28. The method of claim 24, further comprising storing the calling number and called number identification information.

29. The method of claim 28 further comprising transmitting the called number identification information in response to a request therefor.

30. The method of claim 29 wherein the called number identification information is located using a temporary routing number (TRN) associated with a selected WPP.
